(19) United States
(12) Patent Application Publication
(10) Pub. No.: US 2009/0105925 A1
(43) Pub. Date: Apr. 23, 2009

(54) Vehicle travel history provision system

(75) Inventor: Ryuuji Harada, Toyohashi-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/288,439

(22) Filed: Oct. 20, 2008

(30) Foreign Application Priority Data
Oct. 23, 2007 (JP) 2007-275652

(51) Int. Cl. G08G 1/00; G06F 7/06; G06F 17/30

(52) U.S. Cl. 701/99; 701/117; 707/3; 707/E17.014

(57) ABSTRACT

A vehicle travel history information provision system is provided by having: a travel information acquisition unit for acquiring travel information of a vehicle orderly from a preceding vehicle; a history information generation unit for generating preceding vehicle travel history information in a selective manner based on a comparison between information from the preceding vehicle and information from a following vehicle; and an output unit for outputting the preceding vehicle travel history information after information generation in combination with installation of a preceding vehicle travel history information acquisition unit for acquiring the preceding vehicle travel history information and a travel support information generation-and-output unit for generating and outputting support information that supports a travel of the vehicle based on the preceding vehicle travel history information.

### CROSS REFERENCE TO RELATED APPLICATION

The present application is based on and claims the benefit of priority of Japanese Patent Application No. 2007-275652 filed on Oct. 23, 2007, the disclosure of which is incorporated herein by reference.

### FIELD OF THE INVENTION

The present disclosure generally relates to a vehicle travel history provision system for use in a vehicle, which relays a travel history information of a preceding vehicle to a following vehicle.

### BACKGROUND INFORMATION

Recently, making traffic system intelligent is rapidly advanced by putting VICS (Vehicle Information and Communication System: registered trademark) for providing traffic information and ETC system (Electronic Toll Collection System in JAPAN) for collecting toll from vehicles without stopping them to practical use.

Further, by utilizing a technology of special narrow band wireless communication (DSRC:Dedicated Short Range Communication) being used as a core of the ETC system, push-type information service system that provides information services from roadside stations regardless of the request for information from the vehicles is widespread. The information provided includes emergency information, advertising information and the like. As a result, providing traffic jam information on a large area collected by using the vehicle detector and surveillance camera becomes possible.

Furthermore, highly convenient road to vehicle traffic information system is invented according to Japanese patent document of, for example, JP-A-2006-202199. The system provides, in addition to the large area traffic information derived from VICS, traffic information with regard to traveling lane and/or waypoints of interests such as a road situation around the vehicle regarding the traveling lane of the road, traffic congestion information on an exit toll gate and the like.

Moreover, a patent document JP-A-2006-023897 discloses, for example, a travel history collection system that transmits to a center device by using a narrow band wireless communication through the narrow band wireless communication or broad ban wireless communication depending on the availability for greatly reducing the communication load of the broad band wireless communication and for relatively quickly transmitting the travel history to the center device in order to accurately generating and providing the traffic information.

In the examples of above disclosures, provided information includes various types of vehicles in a huge amount of volume, thereby presenting an only average trend of collected information, without distinguish vehicle types and the like. Therefore, it is not likely for the user to utilize the information even when the collected information is available. For instance, when information provided for the user who is driving a passenger car is mainly about a track type vehicle, the information doesn't always provide reference of driving of the user because the driving pattern of the track and the passenger car is substantially different.

Moreover, because information provided for the user is totaled data, the information may not necessarily be directly comparable and utilizable for the vehicle that travels the same portion of the road with a very little time lag due to the lack of real-timeness.

Moreover, even when the above system is configured to establish communication between the terminal device and the center device through a roadside device in terms of acquisition and provision of various information besides having direct communication between the terminal devices on the vehicle and the center device, the above problems are not solved.

Moreover, information provided from the center device is based on travel history information collected from a predetermined coverage area that centers around the position of the center device. Therefore, the provided information may include irrelevant information such as position information that is not traveled by the user, area information that does not include a travel direction of the user, thereby leading to a time-consuming process for extracting required information.

### SUMMARY OF THE INVENTION

In view of the above and other problems, the present disclosure provides a vehicle travel history provision system that promptly provides required information for a user.

In an aspect of the present invention, the vehicle travel history provision system includes: a travel information acquisition unit for acquiring travel information of a vehicle regarding a travel of the vehicle orderly from a preceding vehicle; a history information generation unit for generating preceding vehicle travel history information in a selective manner to be output to the following vehicle based on a comparison between information from the preceding vehicle and information from a following vehicle; and an output unit for outputting the preceding vehicle travel history information after information generation.

By having the above configuration, a user of the vehicle travel history provision system receives useful information that is in association with a passenger vehicle of currently driving type, without loss of information by averaging and without having other noise such as travel history of a track type vehicle or the like.

### BRIEF DESCRIPTION OF THE DRAWINGS

Other objects, features and advantages of the present invention will become more apparent from the following detailed description made with reference to the accompanying drawings, in which:

FIG. 1 is a block diagram of a configuration of a vehicle travel history information provision system of the present invention;

FIG. 2 is a block diagram showing a configuration of an on-board equipment;

FIG. 3 is a diagram of setup information (vehicle information and vehicle type specific information);

FIG. 4 is a block diagram of a configuration of database server;

FIG. 5 is a diagram of an example of travel history information;

FIG. 6 is a block diagram of a configuration of a navigation apparatus for vehicle;

FIG. 7 is a diagram of a flow of information in the vehicle travel history information provision system;

FIG. 8 is a flow chart of a preceding vehicle travel history information generation processing;

FIG. 9 is a diagram of a relation between an engine type and a vehicle body weight;

FIG. 10 is a diagram of a relation between displacement and the vehicle body weight;

FIG. 11 is a flow chart of a preceding vehicle travel history information analysis processing;

FIG. 12 is a flow chart of a travel support information generation and output processing; and

FIG. 13 is an illustration of an example of vehicle control executed by the navigation apparatus.

### DETAILED DESCRIPTION

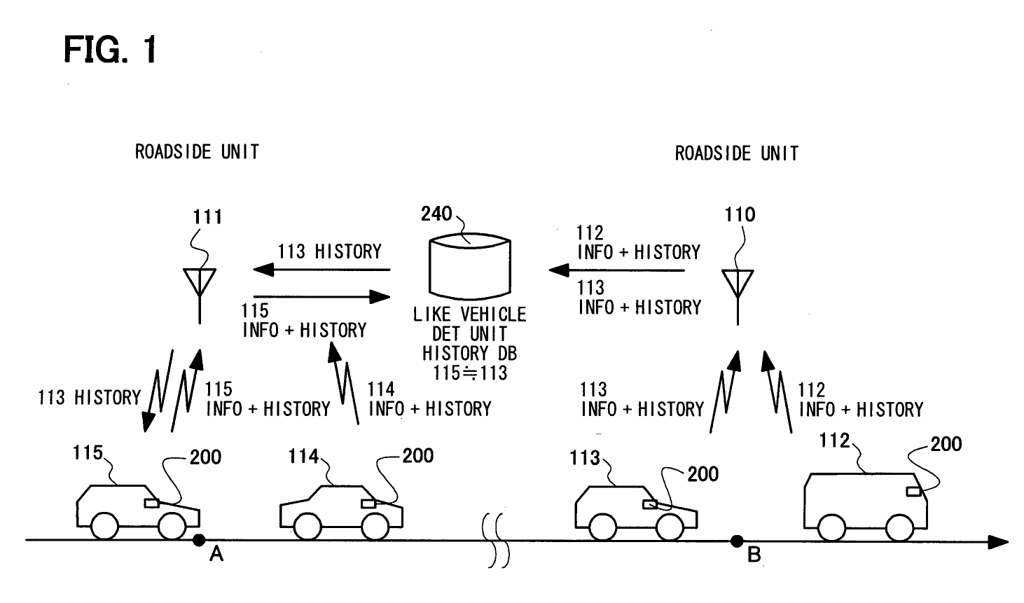

Hereafter, a vehicle travel history provision system of the present invention is described in reference to the drawing. FIG. 1 shows the configuration of a vehicle travel history provision system. Preceding vehicles 112, 113 which run in the vicinity of a point B transmit vehicle information that contains vehicle type specific information and travel history information that contains travel conditions to a roadside wireless unit 110 set up in the vicinity of the point B through an installed on-board equipment 200. The roadside wireless unit 110 transmits received vehicle information and travel history information to a management center 240 (described later in detail). Similarly, a roadside wireless device 111 set up in the vicinity of a point A transmits the vehicle information and the travel history information received from following vehicles 114, 115 that travel in the vicinity of the point A to the management center 240 (described later in detail). The roadside wireless units 110, 111 correspond to a travel information acquisition unit and an output unit for outputting the preceding vehicle travel history information of the present invention.

In the management center 240, the vehicle information and travel history information received from the roadside wireless units 110, 111 are memorized in a travel history data base (history DB), the vehicle information is retrieved, and it is examined whether a similar preceding vehicle that is similar to the following vehicle exists. The preceding vehicle 113 is retrieved as a similar vehicle to the following vehicle 115 in the case of FIG. 1. Then, the retrieved travel history information of the preceding vehicle 113 (preceding vehicle travel history information) is transmitted to the following vehicle 115 through the roadside wireless device 111.

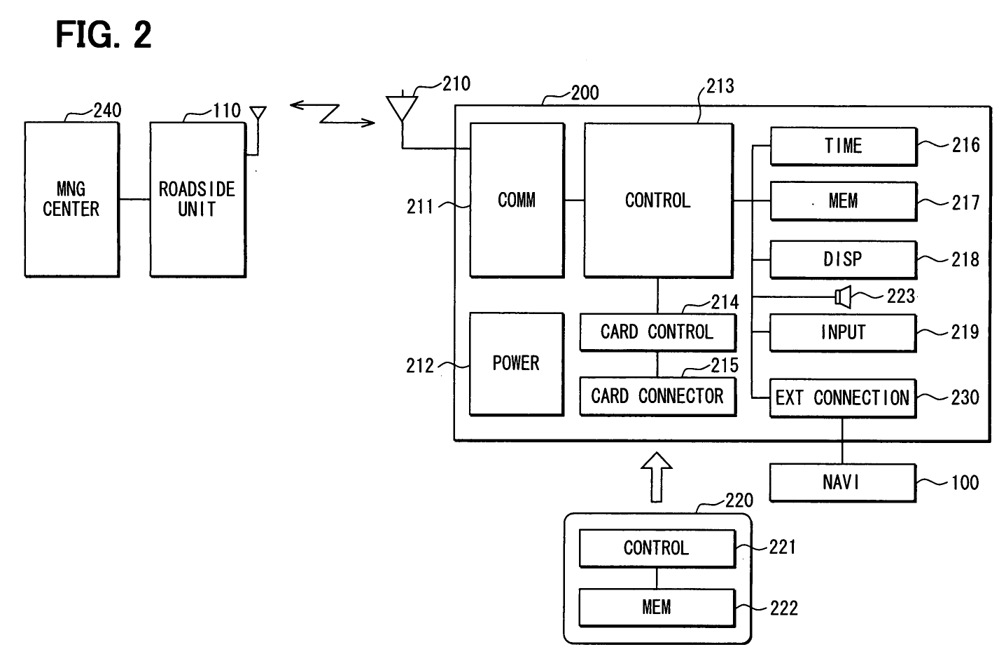

FIG. 2 shows the configuration of the on-board equipment 200. In the present invention, an on-board device of the ETC system (Electronic Toll Collection system in Japan) serves as the on-board equipment. However, the equipment may be a separate device that is independent from the ETC system. The on-board equipment 200 includes an antenna 210 for communication the road with roadside wireless units 110, 111, a communication unit 211 for wireless communication control, a time management unit 216 for generating date and time, a display unit 218 for display operation guidance and tolls for occupants with at least one of LED and LCD display device, a speaker 223 for conveying sound messages, an input operation unit 219 having multiple buttons, an IC card control unit 214 for reading and writing IC card information in an IC card 220 through an IC card connector 215, a total control unit 213 for controlling an entire operation of the on-board equipment 200, and an external device connection unit 230. Further, a power unit 212 supplies power to the whole on-board equipment 200. In this case, the communication unit 211 corresponds to the travel information acquisition unit of the present invention.

As for the total control unit 213, well-known CPU, ROM, RAM, I/O and a bus line for interconnection of those components (not shown in the figure) are provided as well as a signal processing circuit for handling signals from input operations, a signal output circuit for controlling the display unit 218 and the like. The CPU performs control according to a control program and data memorized in the ROM and RAM. The ROM has a program storage area and a data storage area. The control program is stored in the program storage area, and data necessary for the operation of the control program is stored in the data storage area. Moreover, the control program operates by using a work area that is provided as a work memory on the RAM.

A memory unit 217 is composed of a well-known flash memory or DRAM (Dynamic Random Access Memory:dynamic RAM) or the like that can store and provide data. The vehicle type specific information that specifies the type of the vehicle is memorized in the memory unit 217.

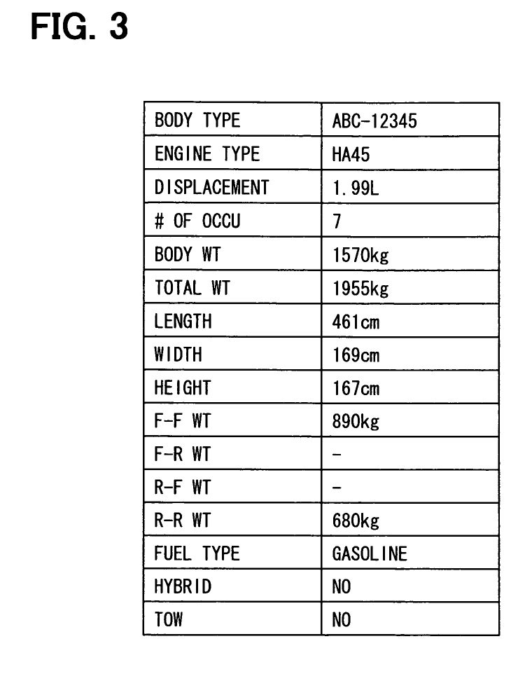

FIG. 3 shows one example of the vehicle type specific information. For instance, the vehicle type specific information is information that appears on the vehicle inspection document (a vehicle certificate that proves passing of a mandatory vehicle inspection in Japan), and the information includes the model of the vehicle, the kind of the motor/engine of the vehicle, the size of the vehicle, the weight of the vehicle, and the type of the fuel of the vehicle and the like.

The vehicle type specific information is written in the memory unit 217 by using the setup work, that is, more practically, data in a setup card is transferred and stored in the memory unit 217. In this case, the memory unit 217 corresponds to a category information storage for storing the vehicle type specific information in the present invention.

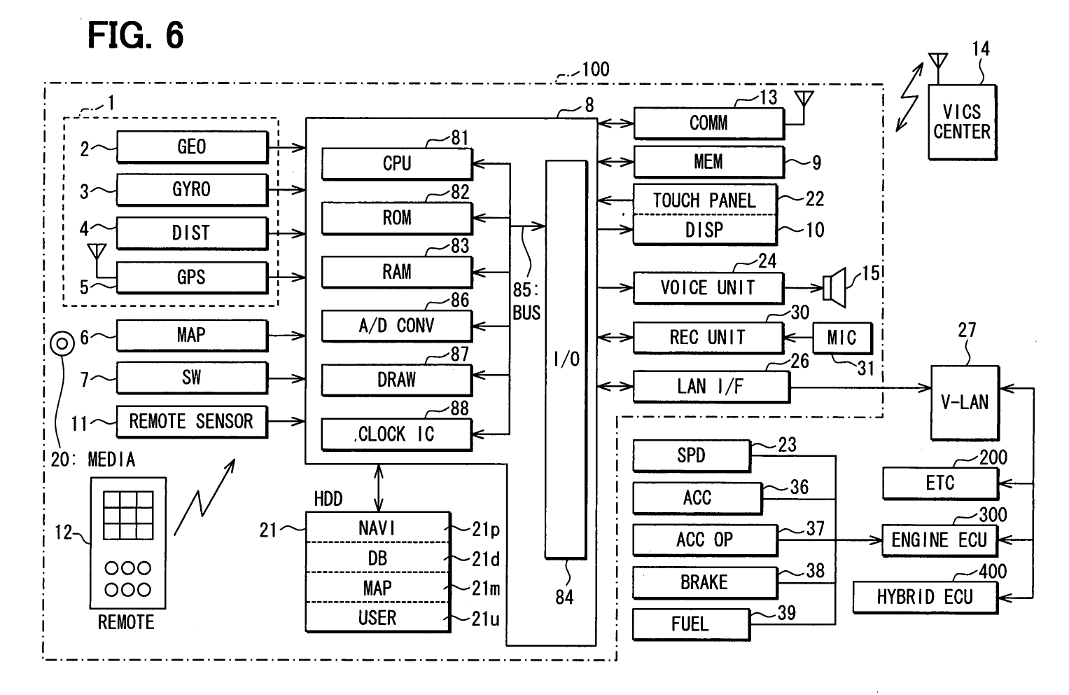

The external device connection unit 230 in FIG. 2 serves, for example, as a communication interface of LAN in the vehicle (an in-vehicle Local Area Network), and provides communication for data exchange with other controllers installed in the vehicle such as a navigation apparatus 100 in FIG. 6 or the like.

When the IC card 220 is inserted in the on-board equipment 200, information in the IC card 220 is retrieved into the on-board equipment 200. This information is transmitted as on-board equipment information with the vehicle information pre-registered in the on-board equipment 200 during the wireless communication. The on-board equipment 200 performs the wireless communication with the roadside machine set up at the entrance or the exit of the toll gate of the toll way for calculating the toll.

The IC card 220 has a memory 222 composed of well-known flash memory or the like for data read/write and a control unit 221 that controls data exchange with the IC card control unit 214 through the connector unit 215 of the on-board equipment 200 and controls the memory 222.

In the memory 222, information necessary for the settlement of the toll is memorized. Moreover, information to identify the IC card 220 (Card ID) and expiration date information of the IC card are also memorized in this memory 222 in advance. When the vehicle enters the toll way through the entrance gate of the toll booth (two or more entrance lanes), the card ID is transmitted to the roadside machine as a portion of the on-board equipment information, and use history information regarding a gate pass time, a gate number for identifying the toll gate, the model of the vehicle and the like transmitted in response to the on-board equipment information is stored in the memory 222 in association with the card ID. Further, the vehicle type specific information may be stored in the memory 222.

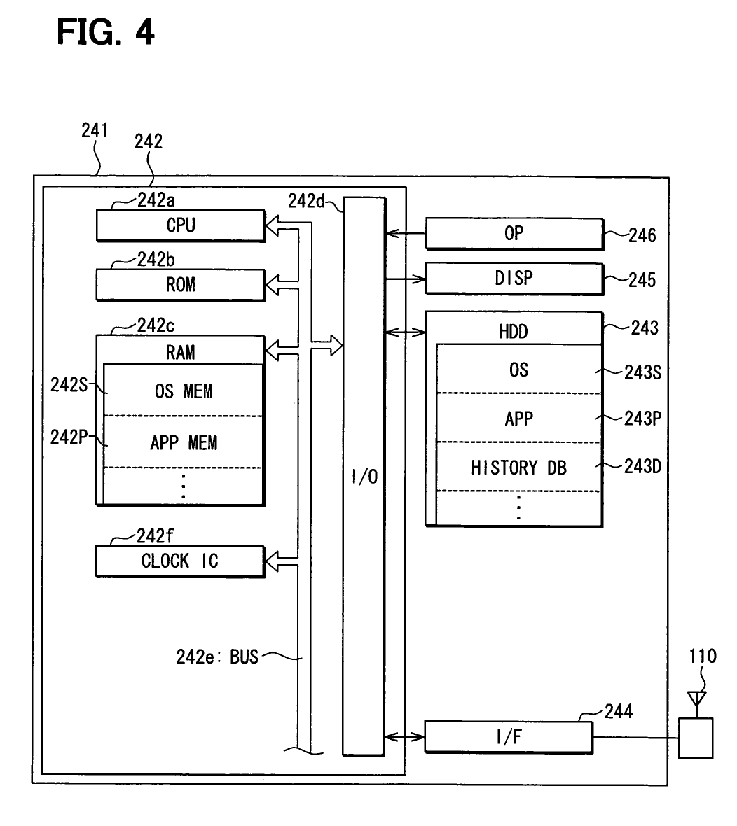

FIG. 4 shows the configuration of a database server 241 set up at the management center. The database server 241 is provided as a well-known personal computer or a workstation, and includes a hard disk drive (HDD) 243, a communication interface (I/F) 244, a display 245, an operation unit 246, and a control unit 242 that connects all of the above components.

The HDD 243 stores an OS program 243S the serves as an operating system (OS)for operating the database server 241, an application program 243P functioning as an application on the OS, and travel history DB 243D and the like.

The communication I/F 244 contains a network circuit that provides the interface function to communicate with the roadside wireless units 110, 111 via communication networks such as Internet network, a telephone network or the like. The communication I/F 244 corresponds to a travel information acquisition unit and a history information generation unit of the present invention.

The display 245 is composed of a device such as a liquid crystal display, a CRT display or the like. The operation unit 246 is composed of an operable device such as a pointing device (a mouse etc.), a keyboard or the like.

The control circuit 242 includes the following components. That is, components such as a CPU 242a, a ROM 242b, a RAM 242c, an input-output interface (I/O) 242d, and a clock IC 242f which has a configuration similar to a clock IC 88 of the navigation apparatus 100 (See FIG. 6) together with a bus line 242e that provides access to those components. The CPU 242a performs control based on the OS program 243S memorized in HDD243. The OS program 243S is executed by utilizing a work memory 242S on the RAM 242c for OS use that serves as a work area. Moreover, the application program 243P is executed by utilizing a work memory 242P on the RAM 242c for application use that serves as a work area. In this case, the control circuit 242 corresponds to a history information generation unit and a search unit of the present invention.

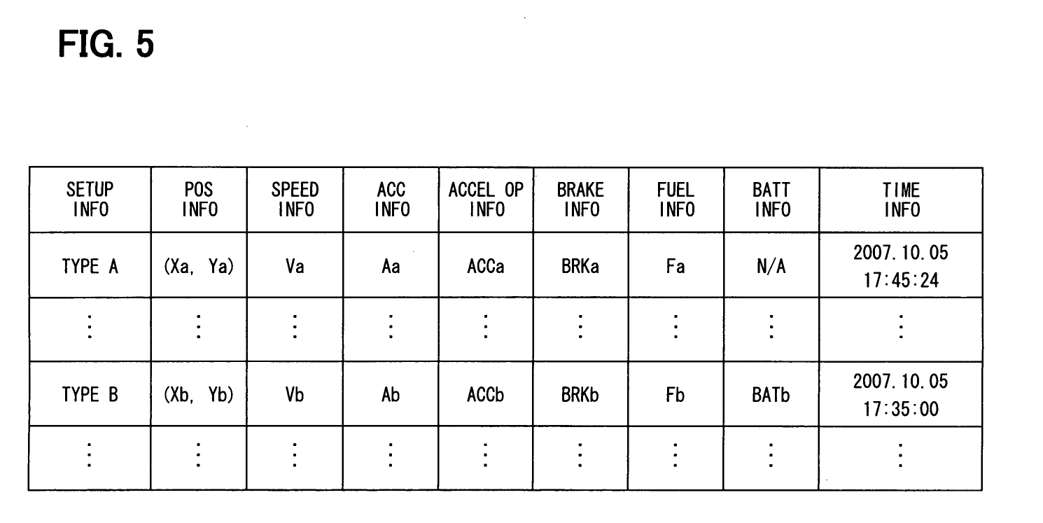

The travel history DB 243D memorizes the travel information of the vehicle (i.e., vehicle information+travel history information) collected by the roadside wireless units 110, 111. FIG. 5 shows an example of the information. The information includes setup information (vehicle information) as well as position information of the vehicle (the roadside device), vehicle speed information, acceleration information, accelerator operation information, brake operation information, fuel consumption information, battery information (chiefly for a hybrid vehicle) and date and time information that marks the date and time when the on-board equipment 200 transmits these information. In this case, the travel history DB 243D corresponds to a database of the present invention.

Moreover, the roadside wireless units 110, 111 may, as an alternative configuration, include the database server 241 for data exchange among the roadside devices.

FIG. 6 shows a block diagram of the configuration of the navigation apparatus 100 (hereafter, abbreviated as NAVI 100) for use in the vehicle. The NAVI 100 has a position detector 1, a map data input unit 6, an operation switch group 7, a remote controller sensor 11, a remote controller 12, a voice unit 24 that synthesizes voice guidance and the like, a speaker 15, a memory 9, a display 10, a communication unit 13, a hard disk drive (HDD) 21, a local area network interface (LAN I/F) 26, a control circuit 8 having connection with these components and the like.

The position detector 1 has a well-known geo-magnetism sensor 2, a gyroscope 3 that detects the angular speed of the vehicle (e.g., vehicle 115 or the like), a distance sensor 4 that detects the travel distance of the vehicle, and a GPS receiver 5 that detects the position of the vehicle on the basis of the electric wave from the satellite. These sensors 2, 3, 4, 5 respectively have the errors of different natures. Therefore, these sensors are used in a mutually compensating manner with each other. Further, depending on the required accuracy, these sensors may be selectively used, or a steering wheel rotation sensor (not shown) and/or tire rotation sensor on each of the wheels such as a speed sensor 23 may be additionally be used. In this case, the position detector 1 corresponds to a travel condition detector and a position detector of the present invention.

As for the operation switch group 7, a well-known touch panel 22 that is provided in combination with, for instance, the display 10 or a mechanical switch is used. A pointing device such as a mouse, a cursor or the like may additionally be used besides the mechanical switch.

Moreover, inputs of various instructions may be performed by using a microphone 31 and/or a voice recognition unit 30. That is, a voice signal from from the microphone 31 is processed by the voice recognition technology of a well-known type such as a hidden Markov model for conversion in the voice recognition unit 30, and is converted into the operation command according to the recognition result. Therefore, various instructions can be input from the operation switch group 7, from the remote controller 12, from the touch panel 22, or from the microphone 31.

The communication unit 13 is a device that receives traffic information or FM multiple broadcasting from, for example, the transmitter on the roadside (not shown in the drawing) by using an optical/radio beacon that conveys VICS traffic information (VICS represents Vehicle Information and Communication System in Japan). Moreover, it is possible to use the configuration that includes external connection connectable to, for example, the Internet or the like by using the communication unit 13.

As for the control circuit 8, a well-known CPU 81, ROM 82, RAM 83, I/O 84 serving as an input/output circuit, an analog to digital (A/D) converter 86, a drawing unit 87, a clock IC 88, and a bus line 85 that connects these components are included. The CPU 81 exerts control by using a navigation program 21p stored in the HDD 21 and data. Further, read and write control for reading and writing data to HDD 21 is controlled by CPU 81. Furthermore, a program that provides a minimum operation for the NAVI 100 may be stored in the ROM 82 as a failsafe measure for a case that the read and write control of the data from the CPU 81 to the HDD 21. In this case, the control circuit 8 corresponds to the search unit of the present invention.

The A/D converter 86 includes a well-known conversion circuit that converts analog signals to digital signals, that is, for example, converts analog signals input form from the position detector 1 or the like to the control circuit 8 to digital signals for processing by the CPU 81.

The drawing unit 87 generates display screen data for various displays on the display 10 based on road map data 21m (described later) memorized in the HDD 21 and/or display color data.

The clock IC 88 is also designated as a real-time clock IC, and transmits or sets data of the clock and the calendar according to the request from the CPU 81. The CPU 81 acquires date and time information from the clock IC 88. Moreover, the date and time information may be acquired from the the GPS signal received by the GPS receiver 5. Moreover, the date and time information may be generated based on the real-time counter included in the CPU 81.

The HDD 21 stores, besides the navigation program 21p, map matching data for improving position detection accuracy as well as road map data 21m that serves as map database including the road data for road connection. The road map data 21m stores map image information that is used for display, and stores road network information including the link information, node information, and the like. The link information is prescribed section information that represents each road, and it is composed of positional coordinates, the distance, the required travel time, the road width, the number of lanes, the speed limit, and the like for the section of the road. Moreover, the node information is information that defines, for example, the intersection (i.e., a divergence of the road) or the like, and it is composed of positional coordinates, the numbers of the right and left turn lane, the ID of the connecting link, and the like. Moreover, link connection information includes information on traffic opening/closure and the like.

Moreover, the user can arbitrarily write supplementary route guidance information and entertainment information as well as data of user's preference. The data of those kinds are stored as user data 21u. Moreover, data required for the operation of the NAVI 100 and various information are also memorized as database 21d.

Addition and renewal of the data can be performed through the through map data input unit 6. For instance, by using a data medium 20, data for in the navigation program 21p, the road map data 21m, the user data 21u, and the database 21 can be updated or renewed in the above-described manner. The medium 20 may be a CD-ROM or a DVD depending on the volume of the data. However, other media such as a memory card or the like may be used. Moreover, data may be downloaded from an external network.

The memory 9 is composed of an EEPROM (Electrically Erasable & Programmable Read Only Memory), a flash memory or the like that provides data rewritability for storing information and data that are required for the operation of the NAVI 100. The memory 9 retains its memory contents even when the NAVI 100 is turned off. Further, the required information and data may be separately memorized on both of the memory 9 and the HDD 21 according to the function and/or operation of the NAVI 100.

The display 10 is composed of a well-known color liquid crystal display device, and includes a dot matrix LCD (Liquid Crystal Display) and a driver circuit for performing the LCD display control. The driver circuit uses, for example, a well-known active matrix drive method, and performs display control based on display instructions and display screen data transmitted from the control circuit 8 (i.e., the drawing unit 87). Further, the display 10 may be composed of, for example, an organic EL (Electro-Luminescence) display unit, or a plasma display unit. In this case, the display 10 corresponds to a travel support information generation-and-output unit of the present invention.

The speaker 15 is connected to a well-known voice synthesis circuit 24, and outputs analogue voice based on digital voice data that is memorized in the memory 9 or the HDD 21 according to the instructions of the navigation program 21p and is converted by the voice synthesis circuit 24. The method of voice synthesis includes record-editing method that combines stored voice waves (either in the wave form or in the coded form) on demand, text synthesis method that uses text input information for synthesizing corresponding sounds or the like. The speaker 15 corresponds to the travel support information generation-and-output unit of the present invention.

The vehicle speed sensor 23 has a rotation detection unit composed of a rotary encoder of well-known type or the like, and transmits a pulse signal by detecting the rotation of the tire. The speed sensor 23 is disposed at, for example, a proximity of a tire disposition portion of the vehicle. In the control circuit 8, the number of tire rotation is converted to the vehicle speed, and expected arrival time from the present position of the vehicle to a prescribed place is calculated besides calculating the average speed of the vehicle in each of the traveled road sections. The speed sensor 23 corresponds to a travel condition detector and a speed sensor of the present invention.

The LAN I/F 26 is an interface circuit for data exchange that is performed with the other vehicle devices or sensors through the vehicle LAN 27. Moreover, the I/F 26 may be used to retrieve data from the speed sensor 23 or other devices. In this case, the LAN I/F 26 corresponds to a travel condition detector, a battery condition detector, a preceding vehicle travel history information acquisition unit, and a travel support information generation-and-output unit of the present invention.

The NAVI 100 executes the following processing by having the above-described configuration when the navigation program 21p is started by the CPU 81 of the control circuit 8 and the user selects from a menu (not shown in the drawing) a route guide process for displaying on the display 10 a destination route by the operation of the operation switch group 7, of the touch panel 22, or of the remote controller 12, or by the voice input from the microphone 31.

That is, when the user searches for the destination and the destination is set, the current vehicle position is determined by the position detector 1 and the processing for calculating the optimum guide route from the current position toward the destination is performed. Then, the guide route is displayed in the road map on the display 10 in a superposing manner as a guidance of an appropriate route for the user. As a technique for automatically setting the best guide route, Dijkstra method is well and publicly known. Moreover, operation guidance and/or operation condition dependent message is output from at least one of the display 10 and the speaker 15.

The acceleration sensor 36 is used for detecting the acceleration in the front-rear direction and the lateral direction of the vehicle (e.g., the vehicle 115), and contains, for example, a piezo-electric type acceleration sensor that is composed of the piezoelectric element which discharges an electrical charge upon receiving inertia. The piezo-electric type acceleration sensor has a structure that binds the piezoelectric element with bases having a certain constant mass. In this case, the acceleration sensor 36 corresponds to a travel condition detector and an acceleration sensor of the present invention.

An accel sensor 37 is used for detecting an amount of stepping of an acceleration pedal (not shown in the drawing), and is composed of a component including a well-known potentiometer. That is, when the acceleration pedal is stepped, the resistance value of the potentiometer changes, and an accordingly changed voltage value in proportion to the resistance value is transmitted to the control circuit 8. In the control circuit 8, the amount of the stepping is calculated based on the voltage value. The accel sensor 37 corresponds to a travel condition detector and an accel operation acquisition unit of the present invention.

The brake sensor 38 is used for detecting an amount of stepping of a brake pedal (not shown in the drawing), and is composed of a component including a well-known potentiometer. That is, when the brake pedal is stepped, the resistance value of the potentiometer changes, and an accordingly changed voltage value in proportion to the resistance value is transmitted to the control circuit 8. In the control circuit 8, the amount of the stepping is calculated based on the voltage value. The brake sensor 38 corresponds to a travel condition detector and a brake operation acquisition unit of the present invention.

A fuel sensor 39 is installed in a fuel tank in the vehicle not shown in the drawing for instance, and the voltage value generated according to the resistance of the potentiometer is transmitted to the control circuit 8 by detecting the position of the floatage that moves up and down according to the position of the liquid level of the fuel and by having the well-known potentiometer installed in an installation position of the floatage. In the control circuit 8, the voltage value is converted to a digital value by the A/D converter 86 and the residue amount of the fuel is calculated by the arithmetic operation. The fuel sensor 39 corresponds to a travel condition detector and a fuel information acquisition unit of the present invention.

The above-mentioned the on-board equipment 200 (“ETC” in FIG. 6) is connected to the vehicle LAN 27, and displays toll information received from the on-board equipment 200 on the display 10. Moreover, information acquired from the above-mentioned position detector 1 and the sensors is transmitted to the on-board equipment 200. The signals and information are acquired from each of the sensors by way of an engine ECU 300 or acquired directly by the on-board equipment 200.

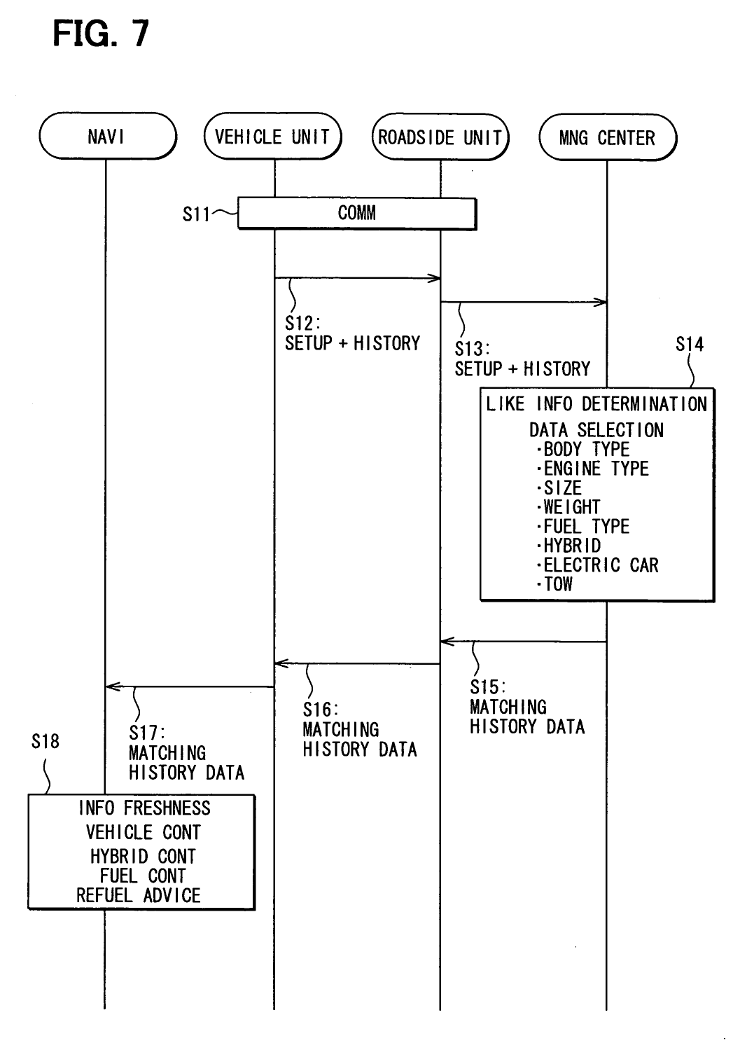

The flow of information in the vehicle travel history provision system of the present invention is described with reference to FIG. 7. First, a wireless communication is started between the on-board equipment 200 and the roadside wireless device (e.g., the unit 110) when the vehicle (e.g., the vehicle 115) enters a communication area of the roadside wireless device (S11). Next, the setup information (i.e., the vehicle information), travel history information (i.e., the vehicle type specific information and travel condition) are transmitted from the on-board equipment 200 to the roadside wireless device (S12). Then, the roadside wireless device transmits the received information to the management center 240 (S13).

In the management center 240, the travel history information is stored in the travel history DB 243D in association with the vehicle information. Then, the travel history information on a similar preceding vehicle to the relevant vehicle is retrieved on the basis of the received vehicle information (S14). For instance, it is examined whether a preceding vehicle that has a similar vehicle type to the relevant vehicle exists in the presumed traveling direction of the relevant vehicle within a predetermined rage based on the position information included in the vehicle information. Then, the travel history data that agrees with the search condition (e.g., the vehicle type) is transmitted to the roadside wireless device that has originally transmitted the vehicle information (S15).

Then, the roadside wireless device transmits the the received information to the on-board equipment 200 (S16). The on-board equipment 200 transmits the the received information to the NAVI 100 (i.e., “NAVI” in FIG. 7) (S17). In the NAVI 100, the freshness (i.e., old and new in terms of information reception) of the received information is examined, and it uses it for the vehicle control (S18). The object and the contents of the vehicle control are described later.

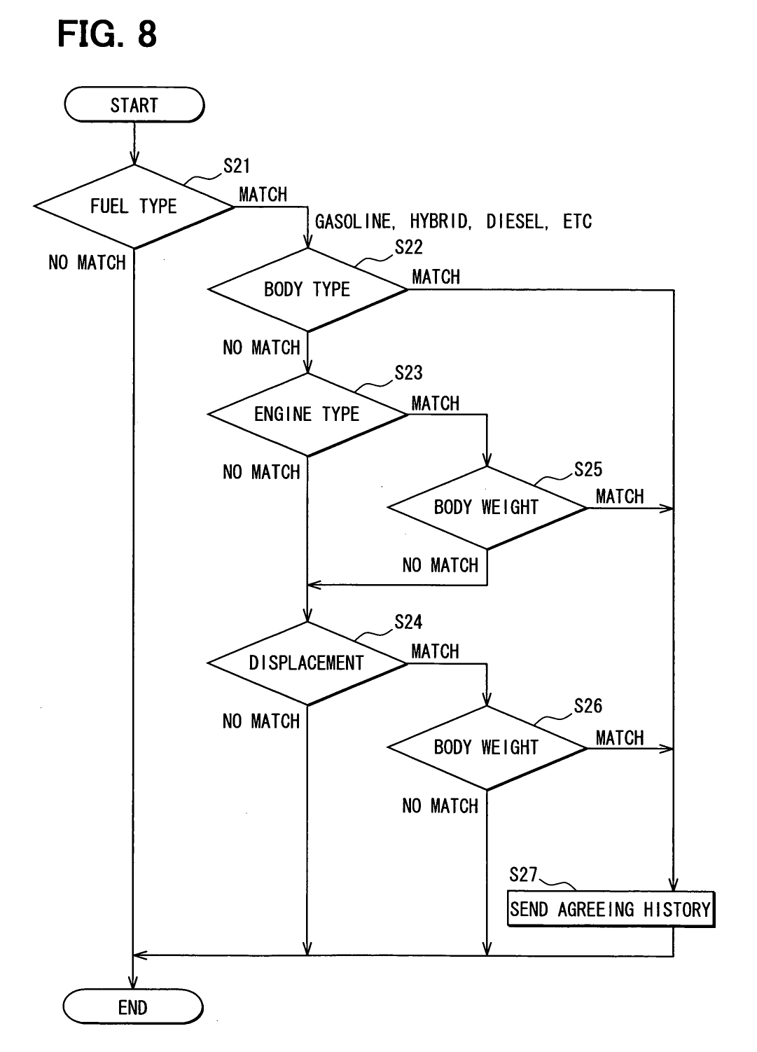

The travel history information generation processing for the preceding vehicle in S14 of FIG. 7 is described with reference to FIG. 8. This processing is included in the application program 243P of the database server 241 installed in the management center 240, and is executed repeatedly with other processing of the application program 243R First, this processing is ended when no information is found in a search by a search keyword of fuel type picked up from the vehicle information (i.e., vehicle type specific information) from the following vehicle for the history DB 243D (S21: NO MATCH).

On the other hand, when the fuel type of gasoline, diesel, or the hybrid, etc. (S21:MATCH) that is matching with the entry in the travel history DB 243D is found, the travel history DB 243D is further searched for by using a search keyword of vehicle body type (BODY TYPE in the drawing). If a matching preceding vehicle is found as a result of the search (S22:MATCH), the travel history information of the preceding vehicle is transmitted to the roadside wireless device (100) as the preceding vehicle travel history information (S27).

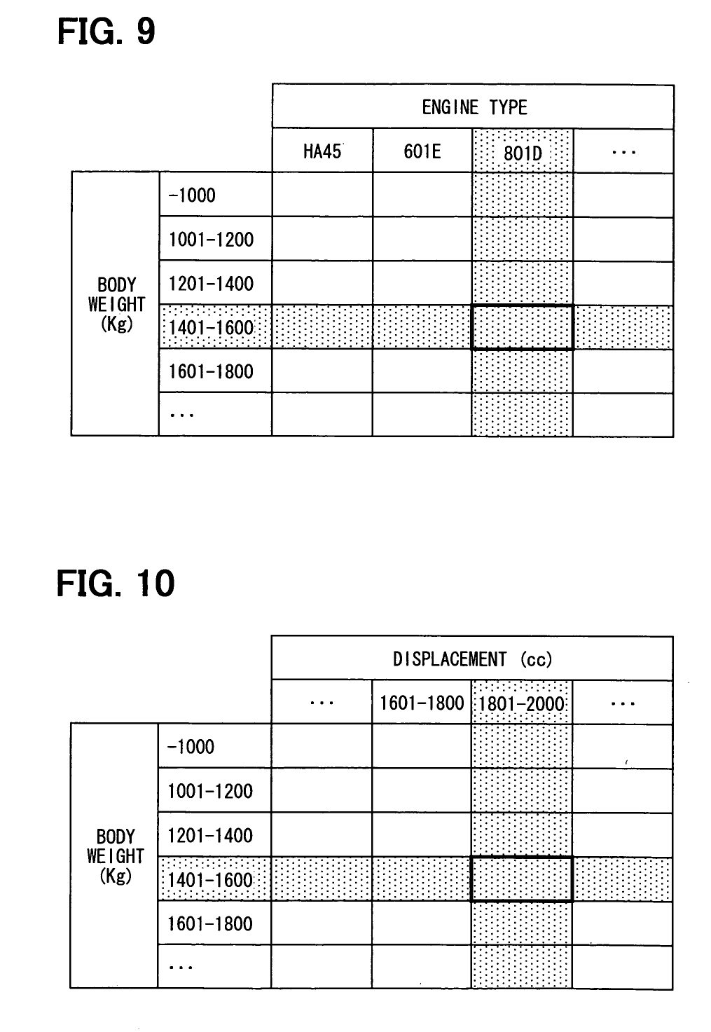

When no matching preceding vehicle is found in terms of vehicle type (S22:NO MATCH), the travel history DB 243D is searched by using a search keyword of engine type (S23). If a matching preceding vehicle is found as the result of search (S23:MATCH), the vehicle weight is used for narrowing the search. This is because a lot of vehicles that have different weight with the same engine type exist as shown in FIG. 9. That is, if the weight is different, the fuel consumption, acceleration, and pedaling work of accelerator and brake are also different. Thus, if the narrowing search is conducted by using the weight of the vehicle, the accuracy of the preceding vehicle travel history information improves, and the vehicle control can also be accurately conducted. In the example of FIG. 9, a preceding vehicle having an engine (motor) type of 801D with the weight between 1401 and 1600 kg is searched.

When a preceding vehicle having the same engine type and the vehicle weight is found (S25:MATCH), the process proceeds to the above-mentioned step of S27.

When no preceding vehicle having the same engine type is found (S23:NO MATCH), or when no preceding vehicle having the same engine type and vehicle weight is found (S25:NO MATCH), the process proceeds to perform a search for the travel history DB 243D by a keyword of displacement of the vehicle. When no matching preceding vehicle is found as a result of the search (S24:NO MATCH), the processing is ended.

On the other hand, when a matching preceding vehicle is found (S24:MATCH), the narrowing search is performed by the vehicle weight as mentioned above. The reason for the narrowing the search by the displacement is that a lot of vehicles having different weight exist as shown in FIG. 10. In the example of FIG. 10, a preceding vehicle having the displacement of 1801-2000 cc and the weight of 401-1600 kg is searched.

When no matching preceding vehicle is found as a result of the narrowing search (S26:NO MATCH), the processing is ended. On the other hand, when a matching preceding vehicle in terms of the displacement and the weight is found (S26:MATCH), the above-mentioned step S27 is performed.

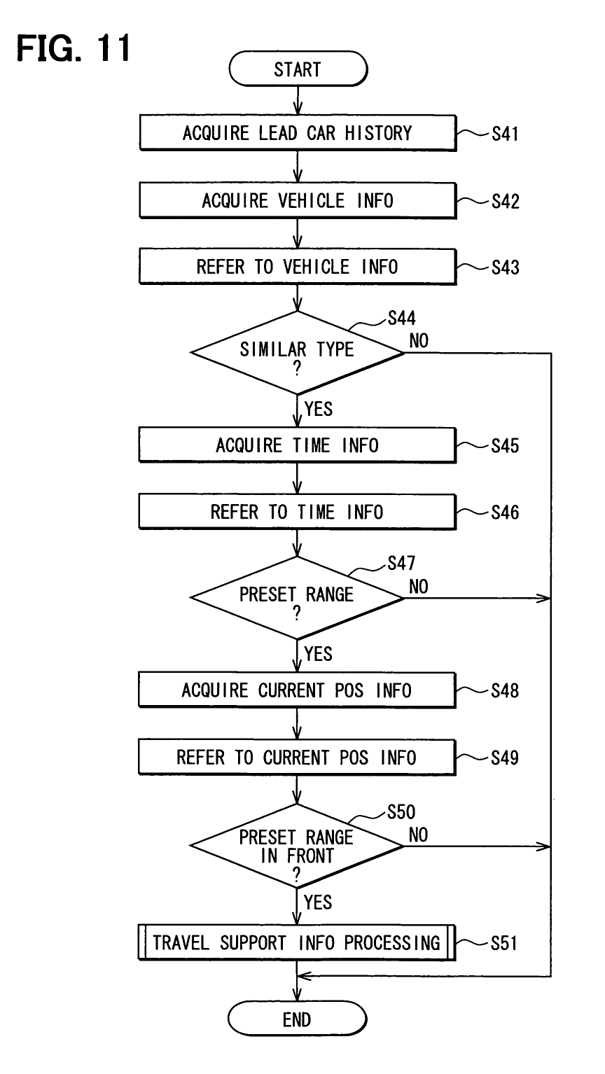

The preceding vehicle travel history information analysis processing that corresponds to S18 of FIG. 7 is described with reference to FIG. 11. This processing is included in the navigation program 21p, and is executed repeatedly with other processing of the navigation program 21p. First, the preceding vehicle travel history information (LEAD CAR HISTORY in the drawing) is acquired from the on-board equipment 200 (S41).

Next, the vehicle information (vehicle type specific information) included in the preceding vehicle travel history information is acquired (S42). Then, referring to the vehicle information memorized in the memory unit 217 of the on-board equipment 200 (S43), it is determined whether the vehicle type included in the memorized vehicle information is similar to the vehicle type in the travel history information of the preceding vehicle. When the vehicle type is searched at the management center 240, step S42 to S44 in the processing need not be executed.

When the vehicle type is similar (S44:Yes), date and time information in the preceding vehicle travel history information is acquired (S45). Then, it is determined whether the date and time of the history information is within a predetermined range referring to date and time information acquired from the clock IC 88 (S46). The predetermined time range may be a constant value such as 30 minutes for instance, or the determination of the arrival of the vehicle being within the predetermined time range may be made by calculating the expected arrival time to the current position included in the information from the preceding vehicle based on the actual location derived from the position detector 1, the vehicle speed from the speed sensor 23, and the current position in the preceding vehicle travel history information. The above determination may be made at the management center 240 for narrowing the information.

When the preceding vehicle travel history information is determined to be with in the predetermined time range (S47:Yes), the current position information in the preceding vehicle history information is acquired (S48). Then, it is determined whether the current location included in the preceding vehicle travel history information is within a predetermined front range of the vehicle by referring to the information on the actual location of the vehicle detected by the position detector 1 (S49).

The predetermined range may be, for example, a fan shape range within 30 degrees to the right and left and within 5 km from the current vehicle position, or a 30 minute reachable range by the current vehicle speed detected by the speed sensor 23.

When the position information in the preceding vehicle travel history information is within the predetermined range (S50:Yes), a travel support information generation and output processing for generating and outputting travel support information is executed (S51, described later).

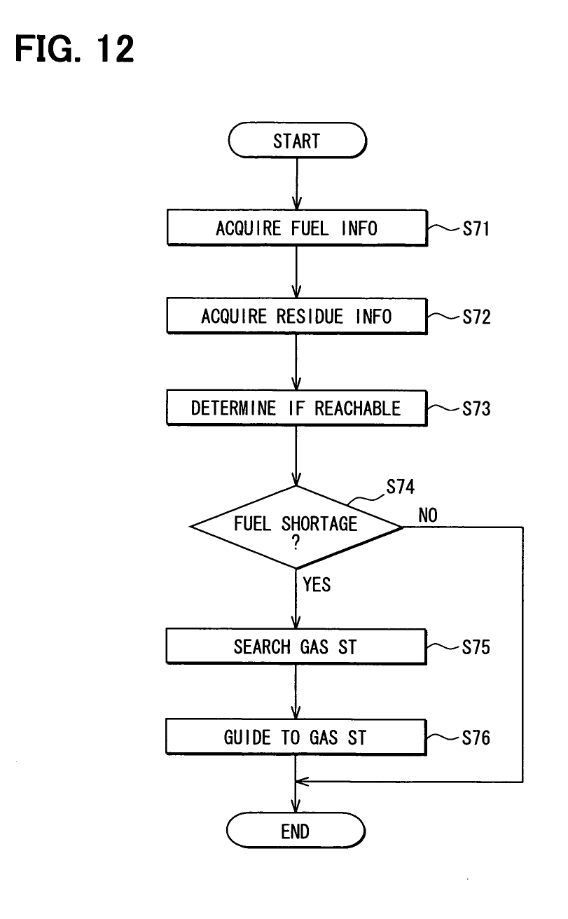

One example of the travel support information generation and output processing that corresponds to step S51 in FIG. 11 is described with reference to FIG. 12. First, fuel consumption information included in the preceding vehicle travel history information is acquired (S71). Next, residue fuel information is acquired from the fuel sensor 39 (S72).

The specific fuel consumption (i.e., consumption rate) in a predetermined section is, for instance, included in the residue fuel information. Therefore, whether it is possible to arrive at the position that is included in the preceding vehicle travel history information is determined based on the position information and the fuel consumption information both included in the preceding vehicle travel history information, the actual position of the vehicle detected by the position detector 1, and the residue fuel information (S73).

When it is not possible to arrive at the position included in the preceding vehicle travel history information by the current amount of the residue fuel, that is, when the fuel shortage is expected (S74:Yes), a gas station in front of the current position of the vehicle is searched with reference to the map data 21m (S75). Then, from the display 10 or speaker 15, a message “The fuel shortage is expected. Please refuel ahead of time.” or the like is output (S76).

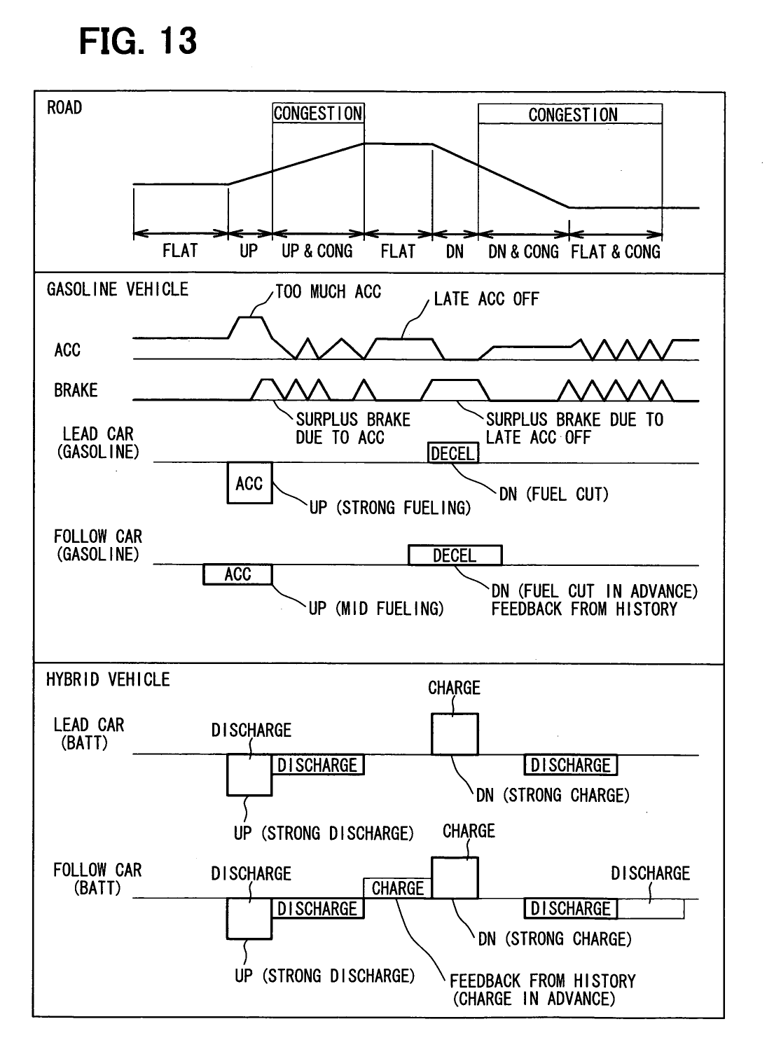

One example of the vehicle control executed by the NAVI 100 is described with reference to FIG. 13. As for “ROAD” in the drawing, the diagram is represented based on topological ground data memorized in the map data 21m and congestion information received by the transceiver 13 from the VICS center 14.

In the example of “GASOLINE VEHICLE”, accel operation information (ACCEL) and brake operation information (BRAKE) included in the preceding vehicle travel history information are displayed. The behavior of the preceding vehicle is estimated from the above-mentioned road related information and accel/brake information. That is:

Stepping on the accel too much in spite of the congestion in the middle of the uphill slope. Therefore, brake operation is iterated due to useless acceleration, thereby resulting in a non-smooth driving. Fuel is injected into the engine by large amount at the acceleration according to the fuel consumption information.

Late acceleration turn off in spite of the traffic congestion in the middle of the downhill slope results in an extended brake operation time.

In view of the preceding vehicle's behavior described above, the fuel injection amount is reduced in comparison to the preceding vehicle so that the following vehicle starts its acceleration in a flat road section before entering the uphill slope and performs the minimum brake operation before reaching the congestion section in the middle of the slope.

Moreover, in view of the congestion in the middle of the downhill slope, the fuel injection is cut off to slow down the vehicle in advance.

The engine rotation control is performed by a well-known engine ECU 300 (see FIG. 6) that controls engine rotation on the basis of degree of an accelerator opening and information from various sensors. As for the technology for controlling engine by acquiring information from other in-vehicle equipment such as the navigation apparatus and the like, JP-A-H05-180023 or JP-A-2007-198227 discloses an exemplary method.

The NAVI 100 and the engine ECU 300 are connected by the vehicle LAN 27. The control mentioned above leads to an output of control as a fuel injection control instruction that specifies the amount of the fuel that should be injected from the NAVI 100 to engine ECU 300. Then, the engine ECU 300 performs the engine rotation control by determining the fuel injection amount based on the output of the fuel injection control instruction.

In the example of “HYBRID VEHICLE”, the vehicle performs the following control in the above section of the road. That is, in the uphill slope, strong discharge for acceleration is changed to normal discharge, and in the downhill slope, charging as a compensation for the discharge is performed with the discharge in the congested section in the middle of the downhill slope. Therefore, by foreseeing to consume the electric power of the battery due to the congestion in the middle of the downhill slope based on the behavior of the preceding vehicle, charging of the electricity is advised in the flat section of the road after climbing the uphill slope.

The NAVI 100 and a hybrid ECU 400 (see FIG. 6) are networked with each other by the vehicle LAN 27. The control mentioned above outputs to the hybrid ECU 400 from the NAVI 100 whether the charging is performed or not as an electrical charge and discharge control instruction. Then, the hybrid ECU 400 performs the battery charge and discharge control on the basis of the output electrical charge and discharge control instruction. As for the method of controlling travel modes of a hybrid vehicle in cooperation with the navigation apparatus, JP-A-H07-107617 or JP-A-2007-168743 discloses an exemplary method.

As for the present invention, the examples in the above-described embodiments are for illustration purposes, and various changes and modifications can be made possible based on the knowledge of those skilled in the art within the scope and sprit of the present invention as defined in the appended claims.

What is claimed is:

1. A vehicle travel history provision system comprising:
a travel information acquisition unit for acquiring travel information of a vehicle orderly from a preceding vehicle, wherein the travel information represents information on a travel of the vehicle;
a history information generation unit for generating preceding vehicle travel history information in a selective manner based on a comparison between information from the preceding vehicle and information from a following vehicle, wherein the preceding vehicle travel history information is to be output to the following vehicle; and
an output unit for outputting the preceding vehicle travel history information after information generation.

2. The vehicle travel history provision system of claim 1 further comprising a category information storage installed in a vehicle for storing category information that represents what category a vehicle belongs to, wherein
the preceding vehicle information includes the category information of the preceding vehicle.

3. The vehicle travel history provision system of claim 2, wherein
the category information at least includes one of a vehicle model, an engine type of the vehicle, a vehicle weight, and a vehicle fuel.

4. The vehicle travel history provision system of claim 1 further comprising a travel condition detector for detecting a travel condition of the vehicle, wherein
the preceding vehicle information includes the travel condition of the preceding vehicle.

5. The vehicle travel history provision system of claim 4 wherein
the travel condition detector includes a position detector for detecting a current position of the vehicle.

6. The vehicle travel history provision system of claim 4 wherein
the travel condition detector includes a speed sensor for sensing a speed of the vehicle.

7. The vehicle travel history provision system of claim 4, wherein
the travel condition detector includes an acceleration sensor for sensing an acceleration of the vehicle.

8. The vehicle travel history provision system of claim 4, wherein
the travel condition detector includes an accel operation acquisition unit for acquiring operation information of an acceleration pedal of the vehicle.

9. The vehicle travel history provision system of claim 4, wherein
the travel condition detector includes a brake operation acquisition unit for acquiring operation information of a brake pedal of the vehicle.

10. The vehicle travel history provision system of claim 4, wherein
the travel condition detector includes a fuel information acquisition unit for acquiring fuel consumption information of the vehicle.

11. The vehicle travel history provision system of claim 4, wherein,
if the vehicle includes a driving motor and an internal combustion engine for supplying a power source to be used in an alternating manner, the travel condition detector includes a battery condition detector for detecting a condition of a battery that supplies electric power for the driving motor.

12. The vehicle travel history provision system of claim 4, wherein
the travel condition detector includes a date and time information acquisition unit for acquiring information of date and time, and
the history information generation unit selects the travel information of the preceding vehicle based on the date and time information.

13. The vehicle travel history provision system of claim 1 further comprising:
a database for storing received travel information of the vehicle for respective vehicles; and
a search unit for searching for the database the travel history information of the preceding vehicle, wherein the travel history information of the preceding vehicle must include information at least partially matching with the vehicle category information acquired from the following vehicle, wherein
the history information generation unit generates the preceding vehicle travel history information based on the travel history information of the preceding vehicle resulting from the searching.

14. The vehicle travel history provision system of claim 1, wherein
the vehicle includes a preceding vehicle travel history information acquisition unit for acquiring the preceding vehicle travel history information and a travel support information generation-and-output unit for generating and outputting support information that supports a travel of the vehicle based on the preceding vehicle travel history information.

15. The vehicle travel history provision system of claim 14, wherein
the travel support information generation-and-output unit generates and outputs a fuel injection control instruction for an engine of the vehicle.

16. The vehicle travel history provision system of claim 14, wherein,
if the vehicle includes a driving motor and an internal combustion engine for supplying a power source to be used in an alternating manner, the travel support information generation-and-output unit generates and outputs a battery charging and discharging instruction for the battery of the vehicle.

17. The vehicle travel history provision system of claim 14, wherein
the travel support information generation-and-output unit generates and outputs refueling support information that suggests refueling of the vehicle based on the current position of the vehicle, the fuel consumption information, and the fuel consumption of the preceding vehicle at the current position.

18. The vehicle travel history provision system of claim 1, wherein
the acquisition of both of the travel information of the preceding vehicle and the travel information of the following vehicle as well as the output of the travel history information of the preceding vehicle are performed through a dedicated short range communication (DSRC).
